(19) United States
(12) Patent Application Publication
(10) Pub. No.: US 2007/0080510 A1
(43) Pub. Date: Apr. 12, 2007

(54) Two-piece creeper

(75) Inventor: Jun Ji, Ontario, CA (US)

Correspondence Address: Kam C. Louie, Esq.;c/o LADAS & PARRY, Suite 2100, 5670 Wilshire Boulevard, Los Angeles, CA, 90036-5679, US

(73) Assignee: TORIN JACKS, INC.

(21) Appl. No.: 11/246,749

(22) Filed: Oct. 6, 2005

(51) Int. Cl. B25H 5/00

(52) U.S. Cl. 280/32.6

(57) ABSTRACT

A creeper to be used by a person during inspection, servicing, or repair of vehicles such as automobiles, trucks, trailers, and the like. The creeper-consists of two components that can be connected together by two fastener arrangements involving pre-stressed springs. One component has ends that can be inserted into corresponding ends of the other component. Compressed springs of the fastener arrangements are located at each connection to lock the connected ends together in a secure, but releasable manner. Each of the two components has four wheels and thus can also be individually used for special purposes. This construction makes it very easy to connect the two components together into one complete creeper for use and then to disconnect again into two components for easy, efficient, and cost saving storage or transportation.

### REFERENCE TO DISCLOSURE DOCUMENT CERTIFICATES

Reference is made to U.S. Disclosure Document No. 581623 recorded Jul. 5, 2005, and entitled “Two Piece Convertible Creeper”, the entire contents of which is incorporated herein by reference.

### BACKGROUND OF THE INVENTION

1. Field of the Invention

This invention relates to the field of automobile repair accessories, and in particular to a mechanic's creeper to be used by a person during the inspection, servicing, or repair of vehicles such as automobiles, trucks, trailers, and the like.

2. Brief Description of the Prior Art

The term “creeper” is well known in the art of automechanics. A typical automobile mechanic's creeper is a small, four-wheeled platform that allows a mechanic to move underneath a car, while lying on his or her back, in order to perform checkups and repairs. Quality creepers are typically about 40″ to 47″ long and about 25″ wide, as represented by Northern Industrial Deluxe Creeper (Item #145519), and The Bone Mechanics Creeper (Northern Tool & Equipment, Item #6301).

In an effort to reduce shipping and handling costs and cost of storage and warehousing, some manufacturers have produced smaller length creepers, such as the Lisle Lowrider Creeper (Northern Tool & Equipment, Item #33707). However, the short 36″ length of this creeper is uncomfortable for the mechanic, and does not provide an adequate body resting surface for tall individuals. Moreover, even at a practical minimum length of 36″ in length, the savings in shipping, handling, storage, and warehousing costs are minimal. Additionally, most prior art creepers are considered bulky and awkward to use in situations requiring only a small, rolling, seating area, such as when the user wants to sit on a movable platform, as opposed to lying on it. This would be desirable, for example, while the user is working on a wheel or bumper area of an automobile.

Torin Jacks, Inc., 4355 E. Brickell Street, Ontario, Calif. 91761, has manufactured a two-piece creeper, but uses a separate pin and strap arrangement, the pin passing through aligned holes in mated tubings on the two halves, to secure the halves together. This makes it inconvenient and time consuming when assembling or disassembling the two-piece creeper. The problem is exacerbated if the pin is lost.

### SUMMARY OF THE INVENTION

The present invention overcomes the shortcomings of the prior art by providing a convertible, transformable, or collapsible, two-piece mechanic's creeper that, in its collapsed or disassembled form, is only half the length of its fully expanded, or fully assembled, length, thereby significantly reducing shipping and handling costs, and simplifying storage and warehousing requirements. Additionally, each half of the creeper, approximately equal in size, can be used as an independent half-sized creeper for the purposes of providing a small, rolling, seating surface 13,15, or a dolly for assisted moving of boxes or heavy articles placed on the seating surface 13,15.

The two creeper sections can be joined together to form a fully assembled creeper by employing a releasable attachment arrangement joining at least one set of side rails of the two creeper sections. Preferably, there is provided an attachment arrangement for joining axially aligned pairs of side rails on both sides of the creeper sections.

In accordance with a preferred embodiment of the present invention, each creeper half is unique, in that, one creeper half has a plain body resting top surface, and the other creeper half is similar in construction, but, additionally, has a raised headrest portion along one end thereof.

In accordance with another aspect of the present invention, each creeper half may be structurally identical, and a separate headrest member may be attached to either creeper half. In this manner, the manufacturing costs can be lowered, and only simple assembly of the headrest to either one of the two creeper halves is required by the purchaser/user.

### BRIEF DESCRIPTION OF THE DRAWING

Further objects and advantages and a better understanding of the present invention may be had by reference to the following detailed description taken in conjunction with the accompanying drawings in which:

FIG. 1 is a side elevational view of a fully assembled mechanic's creeper, made in accordance with the present invention;

FIG. 2 is a plan view of the fully assembled mechanic's creeper shown in FIG. 1;

FIG. 3 is a right end elevational view of the mechanic's creeper shown in FIG. 1;

FIG. 4 is a view similar to that of FIG. 2, but with the mechanic's creeper disassembled to show the two-piece construction of the apparatus; and

FIG. 5 is a cross sectional view of one of the side rails, taken along the line 5-5 in FIG. 1, showing the manner of securely connecting one creeper section to the other.

### DETAILED DESCRIPTION OF THE PREFERRED EMBODIMENTS

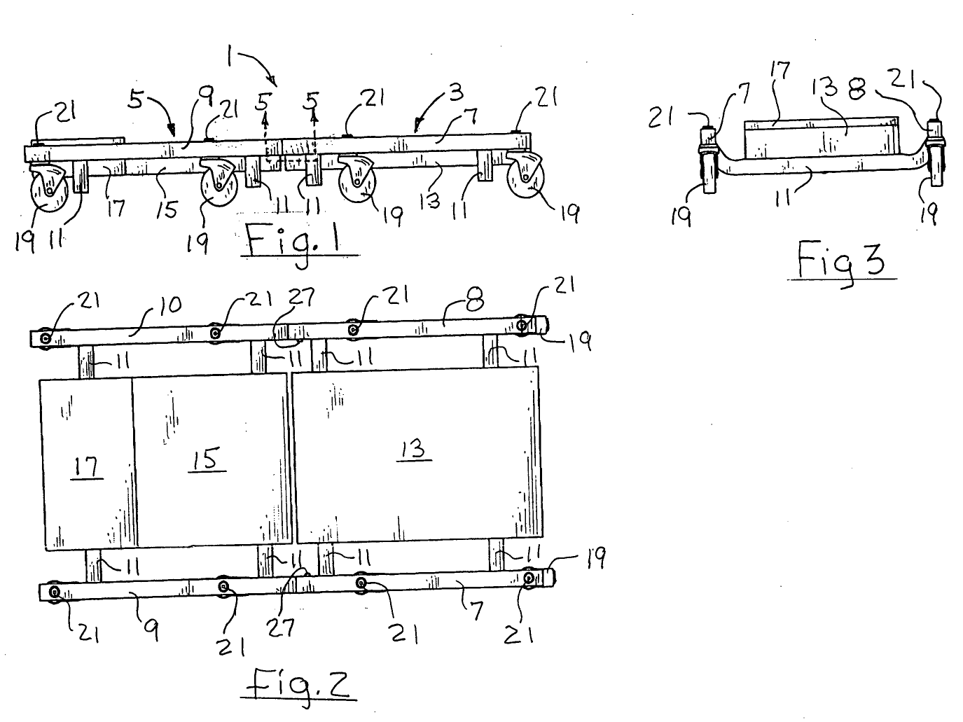

With reference to FIGS. 1-3, there is shown, respectively, a side elevational view, a plan view, and a right end elevational view of a fully assembled mechanic's creeper 1, made in accordance with the present invention.

The creeper comprises two separate sections: a first creeper section, shown in the figures as foot section 3; and a second creeper section, shown in the figures as head section 5.

Each creeper section 3,5 includes a framework comprised, respectively, of a right side rail 7,9, a left side rail 8,10, and a pair of spaced struts, or braces, 11. In this description, when the same reference numeral is used to identify a construction element, it is to be understood such same numbered construction elements are physically identical.

A pair of struts 11 extend between, and are attached to, opposing side rails 7 and 8, and between and attached to opposing side rails 9 and 10.

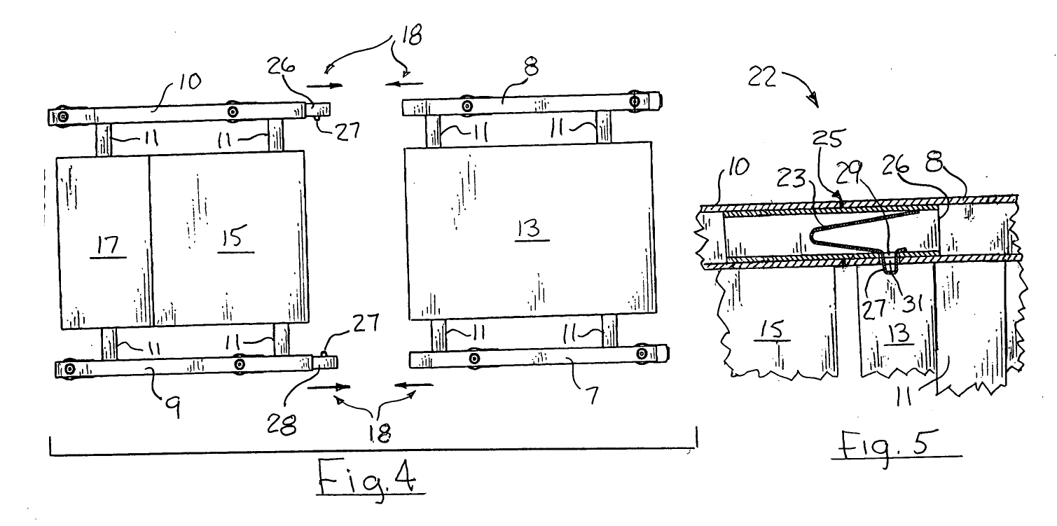

Foot creeper section 3 is shown to have a body rest 13 supported by struts 11, as best seen in FIG. 3. Head creeper section 5 has a body rest 15 similarly constructed and supported, but, additionally, is provided with a raised head rest 17, which is preferably integral with body rest 15 or may be separate and attachable to body rest 15. Both body rests 13 and 15, as well as the head rest 17, are preferably sponge or foam filled cushions covered by tough, oil impervious material.

Four rollers, preferably free wheeling swivel casters 19, are provided for each creeper section 3,5, and are shown mounted to the side rails 7-10, in the positions shown, and secured thereto by nuts 21. The casters 19 are spaced asymmetrically with respect to the length dimension of each creeper section 3,5 in order to provide balanced support for creeper sections 3 and 5 when assembled and connected together, and yet provide adequate balanced support for each individual creeper section 3,5 when disassembled. In this manner, each half of the creeper 1 can be used as an independent half-sized creeper 3,5 for the purpose of providing a small, rolling, seating or dolly platform surface.

FIG. 4 is a view similar to that of FIG. 2, but with the mechanic's creeper 1 disassembled to show the two-piece construction of the apparatus. Arrows 18 depict the required direction of movement for the two creeper sections 3,5 for reassembly.

FIG. 5 is a cross sectional view of the attachment arrangement 22 joining side rails 8 and 10, taken along the line 5-5 in FIG. 1, showing the manner of connecting one creeper section to the other. Preferably, there is provided an attachment arrangement 22 for joining both pairs of side rails 8 & 10 and 7 & 9. For ease of description, the construction and function of an attachment arrangement 22 (see FIG. 5) will be described in connection with the attachment of side rail 8 with side rail 10, as exemplary. A similar attachment arrangement 22 is preferably employed in the connection of side rail 7 with side rail 9, such additional attachment arrangement 22 being contained within tubular extension 28 (FIG. 4).

In the preferred embodiment of the attachment arrangement 22 shown in FIG. 5, an end of side rail 8 abuts the end of side rail 10 as shown by arrow 25 in the drawing. The end of side rail 8 is hollow, and may be of any preferred geometrical shape, e.g., square or circular, in cross section. When assembling creeper sections 3 and 5 together, the end of side rail 10 functions as a female connector member. The end of side rail 10 is also hollow, and encompasses a relatively smaller sized tubular extension 26. Tubular extension 26 is sized to snugly fit into the hollow end of side rail 8, and may be welded to, or wedged into, the hollow tubular end of side rail 10. Alternatively, tubular extension 26 may simply be a narrowed formed end of the side rail 10. In any event, when assembling creeper sections 3 and 5 together, the tubular extension 26 functions as a male connector.

Housed within tubular extension 26 is a spring clip 23 tensioned, or stressed by compression, to apply force against opposite interior wall surfaces of tubular extension 26, as shown. One end of spring clip 23 is bent into the shape of a projecting button 27. In a preferred embodiment of the invention, spring clip 23 is formed from flat plate-like spring material. As shown, the tubular extension 26 is provided with an opening 29 through which button 27 projects.

The hollow side rail 10 is also provided with an opening 31 that registers with opening 29 in the tubular extension 26, such that, when the two openings 29,31 are aligned, button 27 is sufficiently long and sized to snap into and project through both openings 29,31 under the influence of the aforementioned compression of spring clip 23. In this position of button 27, the two side rails 8,10 abut each other (shown at numeral 25), and are securely retained in that condition for so long as button 27 is engaged in both openings 29,31. The result is a fully assembled creeper 1, of standard length, comprised of two separate, securely joined, creeper sections 3,5.

Upon the user pressing button 27 in, button 27 is forced out of a locking condition with opining 31, and the two side rails 8,10 are permitted to be pulled apart. The two creeper sections 3,5 are then ready for use as independent dollies or rolling seating surfaces for the end user, or the separation of the two creeper sections 3,5 are placed one above the other and subsequently wrapped and/or packaged into a convenient sized shipping, storage, or warehousing profile.

When it is desired to again assemble the two creeper sections 3,5 together, the user again pushes button 27 in, sufficiently for button 27 to clear the free end (at 25) of side rail 8; the tubular extension 26 is then slid into side rail 8; and when the facing ends of side rails 8,10 meet (at 25), button 27 snaps into opening 31, and the two creeper sections 3,5 are securely, yet releasably, connected together again, thereby resulting in a fully assembled/expanded creeper 1, as shown in FIGS. 1-3.

What is claimed is:

1. A creeper used by a person during the inspection, servicing, or repair of a vehicle such as an automobile, a truck, or a trailer, and the like, said creeper comprising:
a first creeper section;
a second creeper section; and
an attachment arrangement on said first and second creeper sections for releasably connecting said sections together to form a fully assembled creeper.

2. The creeper as claimed in claim 1, wherein:
said first creeper section comprises a first attachment arrangement part; and
said second creeper section comprises a second attachment arrangement part; whereby
said first and second creeper sections form a fully assembled creeper by engagement of said first and second creeper attachment arrangement parts.

3. The creeper as claimed in claim 2, wherein:
said first creeper section comprises left and right side rails extending along opposite sides of said first creeper section;
said second creeper section comprises left and right side rails extending along opposite sides of said second creeper section;
said first attachment arrangement part comprises respective end portions of said first creeper section left and right rails;
said second attachment arrangement part comprises respective end portions of said second creeper section left and right rails; whereby
said first and second creeper sections form a fully assembled creeper by mutual engagement of said first and second creeper attachment arrangement parts.

4. The creeper as claimed in claim 3, wherein:
said rail end portions of one of said first and second creeper sections have the form of male connectors;
said rail end portions of the other one of said first and second creeper sections have the form of female connectors; and
said male and female connectors may be coupled together to releasably connect said creeper sections together to form a fully assembled creeper.

5. The creeper as claimed in claim 4, wherein:
at least one of said rail end portions, having the form of male connectors, is hollow, tubular, and comprises an internal tensioned spring element, maintained within said rail end portion by the provision of a button-like lateral projection on said spring element passing through an opening formed in a wall of said hollow rail end portion.

6. The creeper as claimed in claim 5, wherein:
at least one of said rail end portions, having the form of female connectors, is hollow, tubular, and has an opening formed in a wall thereof;
said spring element button-like projection, maintained within a cooperating male connector, projects beyond the exterior of said cooperating male connector, and is moved inwardly when said male connector is inserted into a female connector; and
said button-like projection, moves outwardly of said cooperating male connector and into said opening in said female connector wall, thereby securely, yet releasably, locking said cooperating male and female connectors together.

7. The creeper as claimed in claim 1, wherein each of said creeper sections comprises:
a body rest supported by a framework; and
a roller arrangement coupled to said frame to permit free rolling movement of each said creeper section independently of the other creeper section.

8. The creeper as claimed in claim 7, wherein:
one of said first and second creeper sections comprise a head rest attached to an end of said body rest.

9. The creeper as claimed in claim 1, wherein said first and second creeper sections are identical in construction.

10. The creeper as claimed in claim 7, wherein:
one of said first and second creeper sections comprise a head rest attached to an end of said body rest.
